(19) United States
(12) Patent Application Publication
(10) Pub. No.: US 2008/0107446 A1
(43) Pub. Date: May 8, 2008

(54) IMAGE FORMING APPARATUS

(75) Inventor: Ryohei OHTSUKI, Kyoto-shi (JP)

Correspondence Address: MURATA MACHINERY, LTD.;(MURATEC) c/o KEATING & BENNETT LLP, 8180 GREENSBORO DRIVE, SUITE 850, MCLEAN, VA, 22102, US

(73) Assignee: MURATA KIKAI KABUSHIKI KAISHA, Fushimi-ku (JP)

(21) Appl. No.: 11/734,503

(22) Filed: Apr. 12, 2007

(30) Foreign Application Priority Data
Apr. 13, 2006 (JP) 2006-111227

(51) Int. Cl. G03G 21/00

(52) U.S. Cl. 399/124

(57) ABSTRACT

In an image forming apparatus, a jam access cover is mounted to an apparatus body so as to be rotatable with respect to the apparatus body. A manual feeding tray is mounted to the jam access cover in the vicinity of an upper end portion thereof so as to be rotatable with respect to the jam access cover. This allows the jam access cover to be effectively used as a mounting portion for the manual feeding tray.

### BACKGROUND OF THE INVENTION

1. Field of the Invention

The present invention relates to an image forming apparatus including an apparatus body provided with an image forming portion for forming an image on a sheet, a jam access cover for removing a jammed sheet inside the apparatus body, and a manual feeding tray for supplying a manually fed sheet into the apparatus body.

2. Description of Related Art

Some conventional image forming apparatuses include a jam access cover for removing a jammed sheet inside the image forming apparatus and a manual feeding tray for supplying a manually fed sheet into the image forming apparatus. In such an image forming apparatus, a manual feeding opening for supplying a sheet inside is arranged on an upper side of the jam access cover mounted to an apparatus body. The manual feeding tray is mounted to the apparatus body in the vicinity of the manual feeding opening.

In the conventional image forming apparatus, the jam access cover is arranged to be mounted to the apparatus body independently from the manual feeding tray. This causes a problem that there is no space for mounting the jam access cover and the manual feeding tray independently from each other, and therefore, both of the jam access cover and the manual feeding tray cannot be provided at the respective places of the apparatus body in the case of a comparatively small image forming apparatus.

### SUMMARY OF THE INVENTION

In order to overcome the problems described above, preferred embodiments of the present invention provide an image forming apparatus capable of efficiently mounting a jam access cover and a manual feeding tray even on a comparatively small image forming apparatus.

According to a preferred embodiment of the present invention, an image forming apparatus includes an apparatus body provided with an image forming portion for forming an image on a sheet, a jam access cover for removing a jammed sheet inside the apparatus body, and a manual feeding tray for supplying a manually fed sheet into the apparatus body, wherein the jam access cover is mounted to the apparatus body so as to be rotatable with respect to the apparatus body and the manual feeding tray is mounted to the jam access cover so as to be rotatable with respect to the jam access cover.

In accordance with a preferred embodiment of the present invention, the jam access cover is provided with a lock mechanism for preventing rotation with respect to the apparatus body.

In accordance with a preferred embodiment of the present invention, the lock mechanism includes a claw member, which is provided in the jam access cover for interlocking with the apparatus body, and a release lever for releasing the lock between the claw member and the apparatus body.

In accordance with a preferred embodiment of the present invention, the manual feeding tray interlocks with the jam access cover in a predetermined place wherein applying a predetermined pressure to the manual feeding tray causes the lock between the manual feeding tray and the jam access cover to be released.

In accordance with a preferred embodiment of the present invention, the jam access cover is mounted to the apparatus body so as to be rotatable with respect to the apparatus body and the manual feeding tray is mounted to the jam access cover so as to be rotatable with respect to the jam access cover. Accordingly, the jam access cover can be effectively used as a mounting portion for the manual feeding tray. This allows the jam access cover and the manual feeding tray to be efficiently mounted independently from each other even on a comparatively small image forming apparatus. In addition, the apparatus body of the image forming apparatus can be reduced in size.

In accordance with a preferred embodiment of the present invention, the jam access cover is provided with a lock mechanism for preventing rotation with respect to the apparatus body, so that the jam access cover can be prevented from rotating to open simultaneously when only the manual feeding tray is rotated to open. The jam access cover thus does not rotate together when opening only the manual feeding tray. This improves the efficiency of operation.

In accordance with a preferred embodiment of the present invention, the lock mechanism includes a claw member, which is provided in the jam access cover and interlocked with the apparatus body, and a release lever for releasing the lock between the claw member and the apparatus body. Accordingly, releasing the lock between the claw member and the apparatus body by the release lever in order to open the jam access cover allows the jam access cover to be easily opened. The claw member is interlocked with the apparatus body when the jam access cover is closed, so that the jam access cover does not suddenly rotate to open.

In accordance with a preferred embodiment of the present invention, the manual feeding tray interlocks with the jam access cover in a predetermined place wherein applying a predetermined pressure to the manual feeding tray causes the lock between the manual feeding tray and the jam access cover to be released. Accordingly, applying a predetermined pressure to the manual feeding tray allows only the manual feeding tray to be rotated to open in the case of using the manual feeding tray. At that time, the jam access cover is locked by the lock mechanism, and therefore, does not rotate to open.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a front view of an image forming apparatus in accordance with a preferred embodiment of the present invention under a condition that a manual feeding tray and a jam access cover of the image forming apparatus are closed.

FIG. 2 is a front view of an image forming apparatus in accordance with a preferred embodiment of the present invention under a condition that only a manual feeding tray of the image forming apparatus is open.

FIG. 3 is a front view of an image forming apparatus in accordance with a preferred embodiment of the present invention under a condition that a jam access cover of the image forming apparatus is open.

FIG. 4 is a perspective view of a portion in FIG. 1.

FIG. 5 is a perspective view of a portion in FIG. 2.

FIG. 6 is a perspective view of a portion in FIG. 3.

FIG. 7 is a top view of a portion in FIG. 6.

### DETAILED DESCRIPTION OF PREFERRED EMBODIMENTS

Now, an image forming apparatus in accordance with preferred embodiments of the present invention will be described with reference to the drawings.

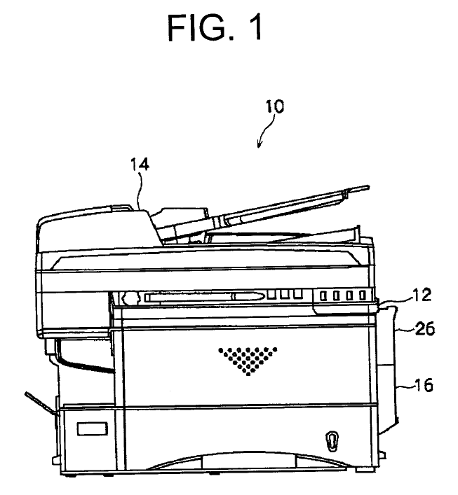

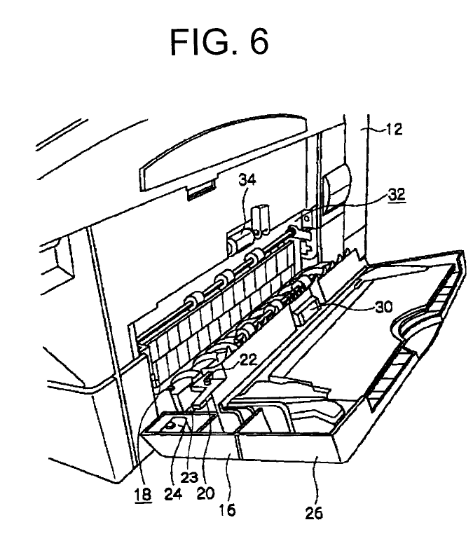

As illustrated in FIGS. 1 to 6, an image forming apparatus 10 includes an apparatus body 12 in which an image forming portion (not illustrated) for forming an image on a sheet is housed. On an upper portion of the apparatus body 12 there is provided an original automatic feeding device 14. A lower end, which acts as a fulcrum, of a jam access cover 16 is mounted to one side surface of the apparatus body 12. The jam access cover 16 is mounted so as to be rotatable with respect to the apparatus body 12 about the lower end. As illustrated in FIG. 6, the jam access cover 16 is mounted to the apparatus body 12 so as to close a jam access opening 18 which is in communication with a sheet carrying path formed inside the apparatus body 12. The jam access opening 18 is arranged to be open to the outside when the jam access cover 16 rotates with respect to the apparatus body 12 to be opened.

As illustrated in FIG. 6, the jam access cover 16 is provided on an inner side surface thereof with a claw member 20. The claw member 20 preferably is formed substantially into the shape of an “L”. A rotation shaft 22 is fitted to a portion of the claw member 20. An end of the rotation shaft 22 is rotatably fitted to the inner side surface of the jam access cover 16. The claw member 20 is thus arranged to rotate about the rotation shaft 22 together with the rotation shaft 22. Further, a portion of the claw member 20 is arranged to interlock with the apparatus body 12.

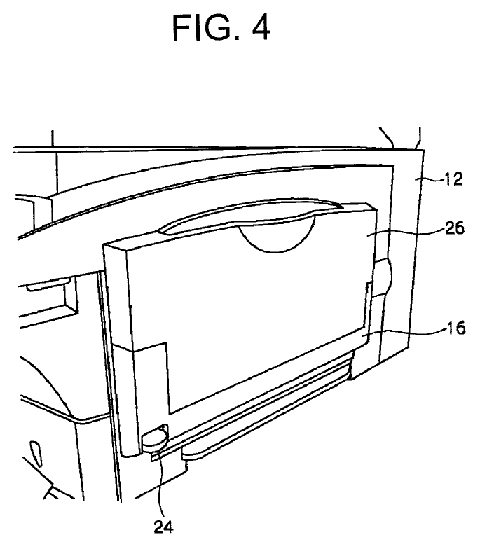

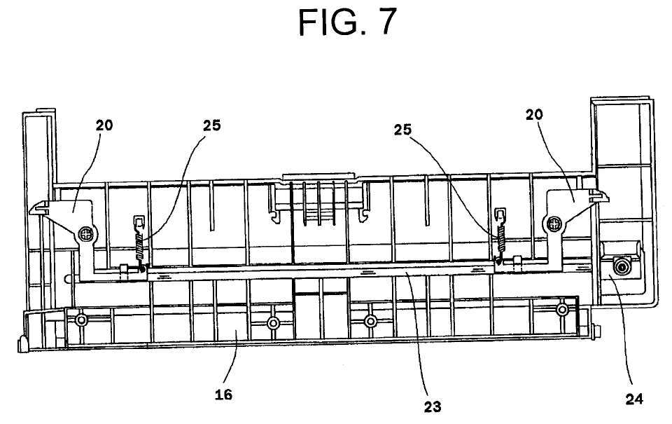

The jam access cover 16 is also provided with a release lever 24 for rotating a shaft 23. The release lever 24 is exposed outside the jam access cover 16 so as to be operated by a user or an operator even when the jam access cover 16 covers the jam access opening 18 of the apparatus body 12, as illustrated in FIGS. 1 and 4. The release lever 24 is mechanically connected to the shaft 23. Pushing up the release lever 24 causes the shaft 23 to be rotated. This allows an interlocking relationship between the claw member 20 and the apparatus body 12 to be released. More specifically, as shown in FIG. 7, one end portion of the claws 20, which respectively make contact with latch members mounted on the shaft 23, is pushed downward. Accordingly, the claw 20 rotates. By this rotational movement, the claws 20 are displaced from the apparatus body 12. When the claws 20 are displaced from the apparatus body 12, the jam access cover 16 can be opened. Releasing the release lever 24 causes the release lever 24 to move back to the original position due to the elasticity of a torsion spring 25 provided in the claw member 20. The shaft 23 rotates in an opposite direction in accordance with the above operation, and thereby, the claw member 20 is interlocked with the apparatus body 12.

A manual feeding tray 26 is mounted in the vicinity of an upper end of the jam access cover 16, which end is a swing side end located on a side opposite to the lower end in the height direction. On both side surfaces of the manual feeding tray 26 are formed convex portions omitted from drawing. The convex portions are rotatably fitted into the jam access cover 16 in the vicinity of the upper end thereof. This allows the manual feeding tray 26 to be rotatable with respect to the jam access cover 16.

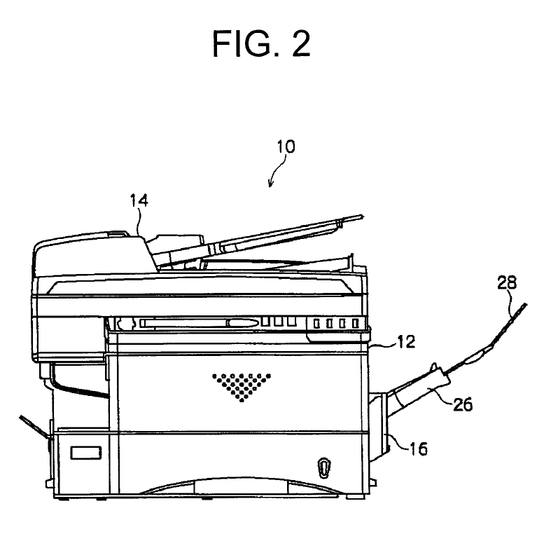

The manual feeding tray 26 is preferably provided with a snap fit portion, which is omitted from drawing. As illustrated in FIGS. 1 and 2, the manual feeding tray 26 interlocks with the jam access cover 16 through the snap fit portion when an exposed surface or an outer surface of the manual feeding tray 26 is in substantially the same plane as an exposed surface or an outer surface of the jam access cover 16. Applying a predetermined pressure to the manual feeding tray 26 so as to open the manual feeding tray 26 under a condition that the manual feeding tray 26 interlocks with the jam access cover 16 allows the lock to be easily released. The jam access cover 16 does not rotate together with the manual feeding tray 26 at that time since the claw member 20 of the jam access cover 16 interlocks with the apparatus body 12.

A sheet guide member 28 is arranged to be mounted to a top end of the manual feeding tray 26 so as to be freely openable, as illustrated in FIG. 2. Accordingly, opening the sheet guide member 28 at the top end of the manual feeding tray 26 when using the manual feeding tray 26 allows a sheet to be held stably in position. The sheet guide member 28 can be folded to be housed on a feeding surface of the manual feeding tray 26 when the manual feeding tray 26 is not used, so that the sheet guide member 28 is not obstructive.

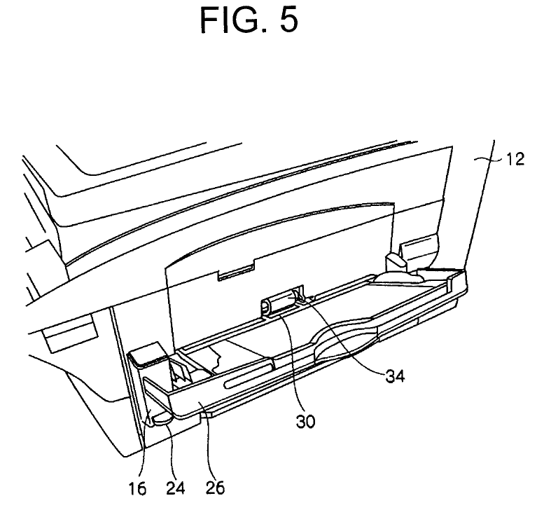

A feeding pad 30 is provided on the inner side surface of the manual feeding tray 26 at approximately a middle portion between the respective convexes formed on both side surfaces of the manual feeding tray 26, as illustrated in FIG. 5. A feeding opening 32 is formed in the vicinity of a lower end of the manual feeding tray 26 of the apparatus body 12, as illustrated in FIG. 6, when the manual feeding tray 26 is rotated with respect to the jam access cover 16 to open the manual feeding tray 26. A driven feeding roller 34 is provided in the vicinity of the feeding opening 32 so that the feeding pad 30 is opposed to the feeding roller 34 when the manual feeding tray 26 is open. Accordingly, the feeding pad 30 is opposed to the feeding roller 34 upon opening the manual feeding tray 26, and then, a sheet placed on the manual feeding tray 26 is held between the feeding roller 34 and the feeding pad 30 to be supplied in order into the apparatus body 12 through the feeding opening 32.

Now, an operation of the image forming apparatus 10 in accordance with a preferred embodiment will be described.

As illustrated in FIGS. 1 and 4, the jam access cover 16 is located on a side surface of the apparatus body 12 so as to close the jam access opening 18 formed in the apparatus body 12 when the manual feeding tray 26 and the jam access cover 16 are not used, and more specifically, when the manual feeding tray 26 and the jam access cover 16 are closed. The manual feeding tray 26 is located on the apparatus body 12 side without being inclined with respect to the jam access cover 16. The sheet guide member 28 is unfolded from the manual feeding tray 26 at that time. Accordingly, the manual feeding tray 26 and the jam access cover 16 can be housed compactly when the manual feeding tray 26 and the jam access cover 16 are not used.

The jam access cover 16 cannot suddenly rotate to open when the jam access cover 16 is closed since the claw member 20 of the jam access cover 16 interlocks with the apparatus body 12. Further, it cannot happen that only the manual feeding tray 26 rotates to open since the manual feeding tray 26 interlocks with the jam access cover 16 through the snap fit portion.

In the case of using the manual feeding tray 26 as illustrated in FIGS. 2 and 5, a predetermined pressure is applied to the manual feeding tray 26 to release the lock between the manual feeding tray 26 and the jam access cover 16 while the manual feeding tray 26 is rotated and inclined with respect to the jam access cover 16. At that time, the jam access cover 16 itself does not rotate even when pressure is transferred to the jam access cover 16 through the manual feeding tray 26 since the claw member 20 of the jam access cover 16 interlocks with the apparatus body 12. This allows only the manual feeding tray 26 to be opened. As described above, the jam access cover 16 does not rotate together with the manual feeding tray 26 when only the manual feeding tray 26 is opened. This improves the efficiency of operation. The manual feeding tray 26 stops at a predetermined angle of inclination with respect to the jam access cover 16.

The feeding pad 30 is arranged to be opposed to the feeding roller 34 when the manual feeding tray 26 is opened. This allows a sheet placed on the manual feeding tray 26 to be held between the feeding roller 34 and the feeding pad 30 and supplied in order into the apparatus body 12 through the feeding opening 32.

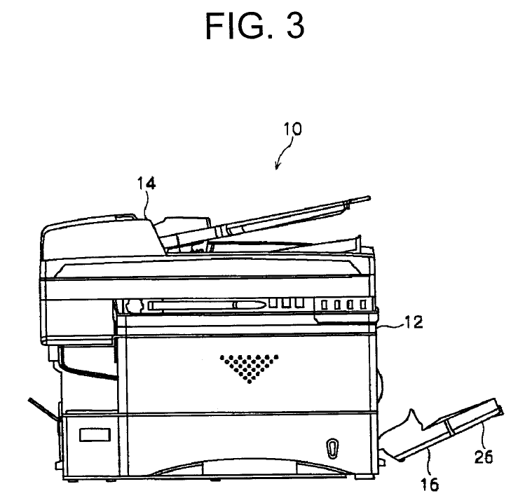

In the case of a jammed sheet inside the apparatus body 12 with the manual feeding tray 26 and the jam access cover 16 being closed as illustrated in FIGS. 1 and 4, it is necessary to open the jam access cover 16. At that time, the release lever 24 of the jam access cover 16 is pushed up to rotate the claw member 20, as illustrated in FIGS. 3 and 6. This causes the lock between the claw member 20 and the apparatus body 12 to be released. After the lock between the claw member 20 and the apparatus body 12 is released, applying the predetermined pressure to the jam access cover 16 to rotate and open the jam access cover 16 allows the jam access opening 18 to be opened. At that time, the manual feeding tray 26 inclines with respect to the apparatus body 12 together with the jam access cover 16 without rotating with respect to the jam access cover 16 since the manual feeding tray 26 interlocks with the jam access cover 16 through the snap fit portion even in the case when a predetermined pressure is applied to the jam access cover 16. Accordingly, operational efficiency in rotation of the jam access cover 16 can be improved. The cause of the jammed sheet can be easily removed since a hand can be inserted into the apparatus body 12 from the jam access opening 18 when the jam access opening 18 is opened as described above.

In accordance with the image forming apparatus 10, as described above, the jam access cover 16 is mounted to the apparatus body 12 so as to be rotatable with respect to the apparatus body 12 while the manual feeding tray 26 is mounted to the jam access cover 16 in the vicinity of the upper end of the jam access cover 16 so as to be rotatable with respect to the jam access cover 16. Accordingly, the jam access cover 16 can be effectively used as a mounting portion for the manual feeding tray 26. This allows the jam access cover 16 and the manual feeding tray 26 to be also efficiently provided in a comparatively small image forming apparatus 10 independently of each other. In addition, the apparatus body 12 of the image forming apparatus 10 can be reduced in size.

While the present invention has been described with respect to preferred embodiments thereof, it will be apparent to those skilled in the art that the disclosed present invention may be modified in numerous ways and may assume many embodiments other than those specifically set out and described above. Accordingly, it is intended by the appended claims to cover all modifications of the present invention that fall within the true spirit and scope of the present invention.

What is claimed is:

1. An image forming apparatus comprising:
an apparatus body;
a jam access cover arranged to allow for removal of a jammed sheet inside the apparatus body; and
a manual feeding tray mounted to the jam access cover so as to be rotatable with respect to the jam access cover.

2. The image forming apparatus according to claim 1, wherein a lower end of the jam access cover is mounted to the apparatus body on a side surface thereof, and the jam access cover is mounted to the apparatus body so as to rotatable about the lower end as a fulcrum for rotation with respect to the apparatus body.

3. The image forming apparatus according to claim 2, wherein the jam access cover is mounted to the apparatus body so as to close an opening in communication with a sheet carrying path formed inside the apparatus body, and the opening is exposed to the outside of the apparatus body when the jam access cover rotates with respect to the apparatus body to open.

4. The image forming apparatus according to claim 3, wherein the jam access cover is provided with a lock mechanism arranged to prevent rotation of the jam access cover with respect to the apparatus body.

5. The image forming apparatus according to claim 4, wherein the lock mechanism is a claw member rotatably provided in an inner side surface of the jam access cover, the claw member is substantially L-shaped and provided with a rotation shaft, and interlocking between a portion of the claw member and the apparatus body causes the jam access cover to be locked in the apparatus body.

6. The image forming apparatus according to claim 5, wherein the lock mechanism is further provided with a release lever arranged to release the lock between the claw member and the apparatus body.

7. The image forming apparatus according to claim 6, wherein the manual feeding tray interlocks with the jam access cover, and applying a predetermined pressure to the manual feeding tray causes the interlock between the manual feeding tray and the jam access cover to be released.

8. The image forming apparatus according to claim 7, wherein a feeding opening is arranged in the vicinity of the lower end of the manual feeding tray, a driven feeding roller is provided in the vicinity of the feeding opening, and the feeding pad is arranged to be opposed to the feeding roller when the manual feeding tray is open.
